(19) United States
(12) Patent Application Publication
(10) Pub. No.: US 2013/0074104 A1
(43) Pub. Date: Mar. 21, 2013

(54) MEDIUM HAVING SPARE AREA, AND RECORDING APPARATUS AND RECORDING METHOD OF THE MEDIUM

(71) Applicant: Kenji Akahoshi, Yokohama (JP)

(72) Inventor: Kenji Akahoshi, Yokohama (JP)

(21) Appl. No.: 13/572,749

(22) Filed: Aug. 13, 2012

(30) Foreign Application Priority Data
Sep. 16, 2011 (JP) 2011-202558

(51) Int. Cl. G11B 7/007; G11B 7/24

(52) U.S. Cl. 720/718; G9B/7.139; G9B/7.029

(57) ABSTRACT

A medium in which information is recorded has: a guide layer of one or two layers each having a spiral track added with address information; and a plurality of recording layers in which depth positions from the guide layer differ. A user data area, spare areas, and a management information storage area for storing information about use of the spare areas are included in each of the plurality of recording layers. An inner peripheral spare area locating on an inner peripheral side of the user data area is configured so as to be used to record the information from an outer peripheral direction toward an inner peripheral direction, and an outer peripheral spare area locating on an outer peripheral side of the user data area is configured so as to be used to record the information from the inner peripheral direction toward the outer peripheral direction.

### INCORPORATION BY REFERENCE

The present application claims priority from Japanese patent application JP-2011-202558 filed on Sep. 16, 2011, the contents of which are hereby incorporated by reference into this application.

### BACKGROUND OF THE INVENTION

The present invention relates to a recording and reproducing apparatus for reproducing or recording information from/into a medium by using a laser and, more particularly, to an allocating method and a using method of an spare area in a medium in which recording and reproduction are executed by using the spare area in the medium.

As related arts, for example, there are the techniques disclosed in the Official Gazette of JP-A-2006-209926, the Official Gazette of JP-A-2007-48350, and M. Ogasawara et. al., “16 Layers Write Once Disc with a Separated Guide Layer”, ISOM2010, Th-L-07.

### SUMMARY OF THE INVENTION

In recent years, in an optical disc of a Blu-ray Disc (registered trade mark) standard, an optical disc having three recording layers and an optical disc having four recording layers have been developed and standardized in addition to the optical disc having one recording layer and the optical disc having two recording layers in the related art. Although it is presumed in the future that an optical disc having a further larger number of recording layers will be developed in order to realize a further large recording capacity, from a viewpoint of manufacturing of the disc, it is presumed that it will be difficult to laminate a number of layers each having a physical groove structure. Therefore, for example, in Ogasawara et. al., in order to make the optical disc to be easily manufactured even in the case of laminating many recording layers, an optical disc (hereinbelow, referred to as a grooveless disc) configured by a layer (hereinbelow, referred to as a guide layer) having a physical groove structure including addresses for performing addressing and tracking servo control and layers (hereinbelow, referred to as recording layers) each of which does not have a physical groove structure such as a land/groove structure and to each of which the recording and reproduction are executed has been disclosed.

In an optical disc medium of a rewritable type or a write-once type, a defect portion on the medium occurs by a scratch due to a partial damage of the medium, a fingerprint, a fouling, a deterioration of a recording film, or the like, and even if the recording is performed to the defect portion, a possibility that data cannot be read out is high. As one of methods of extending a disc life by avoiding such a defect on the disc surface, there is a defect managing method called Linear Replacement in which the data is not recorded into the defect portion but the recording is performed to an spare area (alternate recording area) provided on the same optical disc.

In an optical disc medium of the write-once type such as a DVD-R or the like, there is a case where a finalizing process is necessary in order to improve a compatibility among apparatuses as also disclosed in the Official Gazette of JP-A-2006-209926. The finalizing process in the DVD needs a padding process of an unrecorded area and there is a case where if the finalizing process is executed to a multilayer medium such as a DVD-R DL or the like, it takes a time for the padding as disclosed in the Official Gazette of JP-A-2007-48350. For example, in the case of sequentially recording the DVD-R DL in order of an LO layer and an L1 layer, if an unused area remains in the L1 layer, the padding process is necessary to the end of the L1 layer.

Therefore, as a larger amount of unrecorded area remains, the longer it takes a time for the padding process.

It is, therefore, an object of the invention to solve the foregoing problem and to provide a medium in which a time necessary for a padding process in a grooveless disc can be shortened and to provide a recording apparatus and a recording method of such a medium.

The above problem is solved by, for example, the inventions disclosed in claims. The padding processing time of the spare area can be shortened by the invention. Other objects, features and advantages of the invention will become apparent from the following description of the embodiments of the invention taken in conjunction with the accompanying drawings.

### BRIEF DESCRIPTION OF THE DRAWINGS

FIG. 1 is an example of a layout and a using method of spare areas in an optical disc;

FIG. 2 is a block configuration diagram showing an embodiment of an optical disc apparatus according to the invention;

FIG. 3 is a configuration example of the optical disc according to an embodiment;

FIG. 4 is an example of a processing flow of the optical disc apparatus at the time when the optical disc has been inserted into the optical disc apparatus;

FIG. 5A is an example of a disc structure of a BD-R DL;

FIG. 5B is an example of a disc structure of a BD-RE DL;

FIG. 5C is an example in the case where data has been recorded in spare areas in accordance with a using direction of the spare areas in the disc structure example of FIG. 5A;

FIG. 5D is an example in the case where data has been recorded in spare areas in accordance with a using direction of the spare areas in the disc structure example of FIG. 5B;

FIG. 6A is an example of a disc layout of the spare areas which is considered from the use example of the spare areas in FIG. 1;

FIG. 6B is an example of a disc layout of the spare areas which is considered from the use example of the spare areas in FIG. 1;

FIG. 6C is an example of a disc layout of the spare areas which is considered from the use example of the spare areas in FIG. 1;

FIG. 6D is an example of a disc layout of the spare areas which is considered from the use example of the spare areas in FIG. 1;

FIG. 6E is an example of a disc layout of the spare areas which is considered from the use example of the spare areas in FIG. 1;

FIG. 6F is an example of a disc layout of the spare areas which is considered from the use example of the spare areas in FIG. 1;

FIG. 7A is an example of a DAO (Disc At Once) recording;

FIG. 7B is an example of the DAO recording which solves a problem of the DAO recording shown in FIG. 7A;

FIG. 7C is another example of the DAO recording which solves the problem of the DAO recording shown in FIG. 7A;

FIG. 8 is a flowchart in the case of performing the recording to the spare areas; and

FIG. 9 is a flowchart of a capacity deciding method of the spare areas.

### DESCRIPTION OF THE EMBODIMENTS

An embodiment of the invention will be described hereinbelow with reference to the drawings.

First, a finalizing process is considered by presuming a grooveless disc having spare areas. Although a guide layer of the grooveless disc which is presumed in Ogasawara et. al. mentioned above is a single layer, in this case, in an optical disc having a plurality of recording layers in a related art such as DVD-R DL, BD-R DL, or the like, the recording in what is called an OTP (Opposite Track Path) in which the recording is shifted to the next layer as if the recording is turned back at an end of the layer cannot be performed. Therefore, even in the grooveless disc having a plurality of recording layers, when considering a case where the recording in the OTP is performed in a manner similar to the related art, the recording in the OTP can be realized by a method whereby the guide layer is constructed by double layers in which the spiral directions of the tracks differ and the guide layer to be used is alternately changed every layer which is subjected to the recording or reproduction. Therefore, in the embodiment, in the case of handling the disc structure of two layers, such a grooveless disc in which the guide layer is constructed by double layers in which the spiral directions of the tracks differ is presumed.

Subsequently, a data reproducing process of the grooveless disc will be considered. In the case of performing the data reproduction of the grooveless disc, two methods are considered. One is a method whereby a tracking is applied by using the guide layer and the data in the recording layer is reproduced. The other is a method whereby the guide layer is not used but the tracking process is executed on the basis of only the data recorded in the recording layer and the data is reproduced. In the case of the latter method, although the tracking process is necessary only for the recorded data, in order to execute the tracking process without using the guide layer in the recording layer without a guide groove, a reproducing method using a DPD (Differential Phase Detection) method is considered. In the case of using such a method, as for an area having a possibility that a pickup accesses, it is necessary to record so that there is no unrecorded area. Therefore, in the case of executing the finalizing process of the grooveless disc in which the data has been recorded in the spare area, there is a case where a padding process of the unrecorded area of the spare area is necessary. Since a time necessary for the padding process becomes long in proportion to a capacity of the unrecorded area, if the unrecorded area is large, it takes a long time for the padding process and it causes a deterioration in usability of the user. Since padding data is recorded, there is also a fear of a failure during the recording, a decrease in life due to use of a recording laser, or the like. It is, therefore, desirable that an area where the padding process is executed is as small as possible.

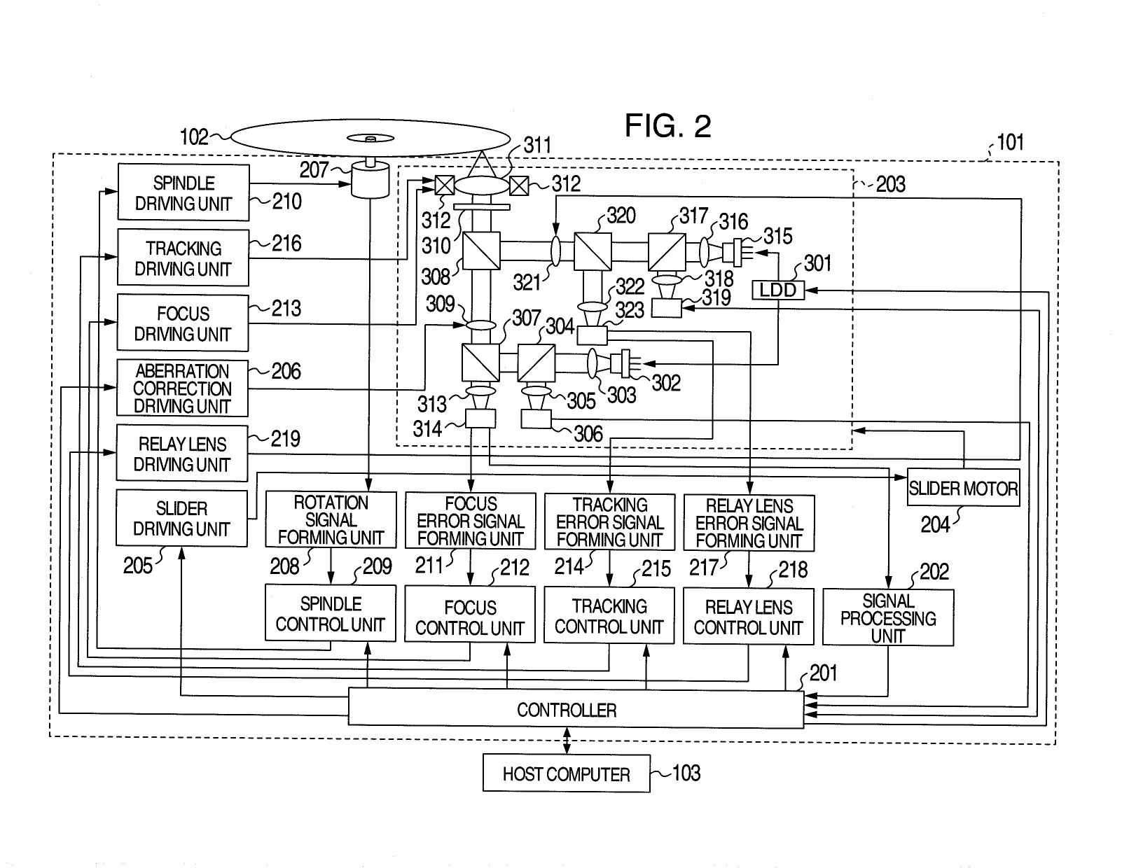

FIG. 2 is a block configuration diagram showing an embodiment of an optical disc apparatus according to the invention.

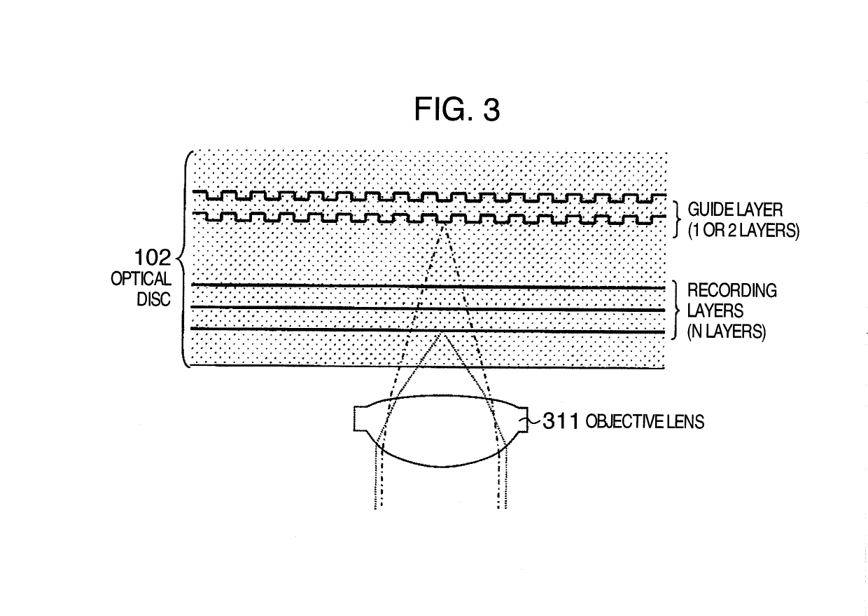

An optical disc apparatus 101 records or reproduces information by irradiating a laser beam to an optical disc 102 loaded into the apparatus and communicates with a host computer 103 such as a PC (Personal Computer) or the like through an interface such as SATA (Serial Advanced Technology Attachment) or the like. An example of a structure of the optical disc 102 is illustrated in FIG. 3. The optical disc 102 is constructed by: a guide layer having a structure of a track (guide groove); and N recording layers (N≧1, N is a natural number) each of which does not have the structure of the track. The optical disc apparatus 101 can cause a laser spot to each of the recording layer and the guide layer by an objective lens 311. Address information has been added to the track of the guide layer. The guide layer is constructed by single layer or double layers. If the track is constructed by double layers, each layer has the track of a different spiral direction.

The optical disc apparatus 101 has: a controller 201; a signal processing unit 202; an optical pickup 203; a slider motor 204 for driving the optical pickup 203 in a radial direction of the optical disc 102; a slider driving unit 205 for driving the slider motor 204; an aberration correction driving unit 206 for driving a spherical aberration correcting element 309 equipped in the optical pickup 203; a spindle motor 207 for rotating the optical disc 102; a rotation signal forming unit 208 for forming a signal synchronized with a rotation of the spindle motor 207; a spindle control unit 209 for forming a rotation signal to rotate the spindle motor 207; a spindle driving unit 210 for driving the spindle motor 207 in response to the rotation signal which is formed by the spindle control unit 209; a focus error signal forming unit 211 for forming a focus error signal showing a deviation amount between a recording layer of the optical disc 102 and a focus position of the laser spot; a focus control unit 212 for forming a focus drive signal in accordance with the focus error signal; a focus driving unit 213 for driving an actuator 312 equipped in the optical pickup 203 in accordance with the focus drive signal; a tracking error signal forming unit 214 for forming a tracking error signal showing a positional deviation amount between the track on the guide layer of the optical disc 102 and the laser spot; a tracking control unit 215 for forming a tracking drive signal in accordance with the tracking error signal; a tracking driving unit 216 for driving the actuator 312 in accordance with the tracking drive signal; a relay lens error signal forming unit 217 for forming a relay lens error signal showing a positional deviation amount between the guide layer of the optical disc 102 and the focus position of the laser spot; a relay lens control unit 218 for forming a relay lens drive signal according to the relay lens error signal; and a relay lens driving unit 219 for driving a relay lens 321 in accordance with the relay lens drive signal.

The optical pickup 203 has two optical systems of different wavelengths such as 405 nm and 650 nm. First, the operation upon reproduction will be described with respect to the optical system of 405 nm. A laser driver 301 is controlled by the controller 201 and outputs a current for driving a laser diode 302. A high frequency component of hundreds of MHz has been superimposed to the drive current in order to suppress laser noises. The laser diode 302 emits a laser beam having a waveform according to the drive current and a wavelength of 405 nm. The emitted laser beam is converted into parallel light by a collimator lens 303, is partially reflected by a beam splitter 304, and is converged to a power monitor 306 by a condenser lens 305. The power monitor 306 feeds back a current or voltage according to an intensity of the laser beam to the controller 201. Thus, the intensity of the laser beam which is converged to the recording layer of the optical disc 102 is held to a desired value of, for example, 2 mW or the like. The laser beam which passed through the beam splitter 304 is reflected by a polarization beam splitter 307 and passes through a dichroic mirror 308. The dichroic mirror 308 is an optical element for reflecting light of a specific wavelength and transmitting light of other wavelengths. It is now assumed that the dichroic mirror transmits the light of the wavelength of 405 nm and reflects the light of the wavelength of 650 nm. A convergence and a divergence of the laser beam which passed through the dichroic mirror 308 are controlled by the spherical aberration correcting element 309 which is driven by the aberration correction driving unit 206 and the laser beam becomes a circular polarization by a quarter-wave retardation plate 310 and is converged to the recording layer of the optical disc 102 by the objective lens 311. A position of the objective lens 311 is controlled by the actuator 312. The intensity of the laser beam reflected by the optical disc 102 is modulated in accordance with information recorded in the optical disc 102. The laser beam becomes a linear polarization by the quarter-wave retardation plate 310, is transmitted through the dichroic mirror 308 and the spherical aberration correcting element 309, and passes through the polarization beam splitter 307. The transmitted laser beam is converged to a detector 314 by a condenser lens 313. The detector 314 detects the intensity of the laser beam and outputs a signal according to the intensity to the signal processing unit 202. The signal processing unit 202 executes processes such as amplification, equalization, decoding, and the like to a reproduction signal outputted from the detector 314 and outputs decoded data to the controller 201. The controller 201 outputs the data to the host 103.

The focus error signal forming unit 211 forms the focus error signal to the recording layer from the signal outputted from the detector 314. In response to an instruction signal from the controller 201, the focus control unit 212 forms a focus drive signal corresponding to the focus error signal to the focus driving unit 213. In accordance with the focus drive signal, the focus driving unit 213 drives the actuator 312 in the direction perpendicular to a disc surface. Since the focus control unit 212 and the focus driving unit 213 operate as mentioned above, focus control is made in such a manner that the laser spot irradiated to the recording layer of the optical disc 102 is always focused onto the recording layer.

When the recording is executed, recording data is inputted from the host 103 to the controller 201. The controller 201 outputs a recording waveform corresponding to the inputted data to the laser driver 301. The laser driver 301 outputs a drive current according to the recording waveform to the laser diode 302 and the laser diode 302 emits a laser beam with the corresponding waveform, so that the recording is performed to the recording layer of the optical disc 102.

Although not shown, the controller 201 has all of the following units necessary to output the data read out of the optical pickup 203 to the host 103 of an external apparatus or to record the data from the host 103 onto the optical disc 102: that is, a unit for modulating and demodulating the data; a unit for performing an error correction; a temporary storing unit for temporarily storing the data; a temporary storing unit control unit for controlling the temporary storing unit; a host I/F unit for performing a transmission and a reception to/from the host 103; and the like. For example, an spare area capacity deciding unit which is necessary at the time of a physical initialization of the disc in the invention, an spare area recording unit which is necessary in a defect management process during the recording, and the like are also included in the controller 201.

Subsequently, the optical system of 650 nm will be described. There is not so large difference between the operations upon recording and reproduction with respect to this optical system. In a manner similar to the optical system of 405 nm, the laser driver 301 drives a laser diode 315 and the laser diode 315 emits a laser beam of a wavelength of 650 nm. A part of the laser beam passes through a collimator lens 316, a beam splitter 317, and a condenser lens 318 and its power is monitored by a power monitor 319. By feeding back the monitored power to the controller 201, the intensity of the laser beam which is converged to the guide layer of the optical disc 102 is held to a desired power of, for example, 3 mW or the like. The laser beam which passed through the beam splitter 317 passes through a polarization beam splitter 320 and a convergence and a divergence of the laser beam are controlled by the relay lens 321. The laser beam which passed through the relay lens 321 is reflected by the dichroic mirror 308, passes through the quarter-wave retardation plate 310, and is converged to the guide layer of the optical disc 102 by the objective lens 311. The laser beam reflected by the optical disc 102 is reflected by the polarization beam splitter 320 and is converged onto a detector 323 by a condenser lens 322.

The tracking error signal forming unit 214 forms the tracking error signal to the guide layer of the optical disc 102 from a signal outputted from the detector 323. In response to an instruction signal from the controller 201, the tracking control unit 215 forms the tracking drive signal according to the tracking error signal. In accordance with the tracking drive signal, the tracking driving unit 216 drives the actuator 312 in the radial direction of the disc. Since the tracking control unit 215 and the tracking driving unit 216 operate as mentioned above, the tracking control is made in such a manner that the laser spot irradiated to the guide layer of the optical disc 102 always traces the track on the guide layer.

From the signal outputted from the detector 323, the relay lens error signal forming unit 217 forms the relay lens error signal serving as an error signal in the focus direction to the guide layer of the optical disc 102. In response to an instruction signal from the controller 201, the relay lens control unit 218 forms the relay lens drive signal according to the relay lens error signal. The relay lens driving unit 219 drives the relay lens 321 in accordance with the relay lens drive signal. By driving the relay lens 321, the focus position of the laser spot which is irradiated to the guide layer changes and a difference between the positions of the recording layer and the guide layer can be compensated. Since the relay lens control unit 218 and the relay lens driving unit 219 operate as mentioned above, relay lens control is made in such a manner that the laser spot irradiated to the guide layer of the optical disc 102 is always focused onto the guide layer.

The slider driving unit 205, aberration correction driving unit 206, and spindle control unit 209 also operate in response to instruction signals from the controller 201.

Although the same laser driver 301 has been used here in order to drive the laser diodes 302 and 315, a unique laser driver may be provided for each laser diode. The spherical aberration correcting element 309 may be arranged at a position which exerts an influence on both of the optical system of 405 nm and the optical system of 650 nm. For example, it may be arranged between the quarter-wave retardation plate 310 and the dichroic mirror 308.

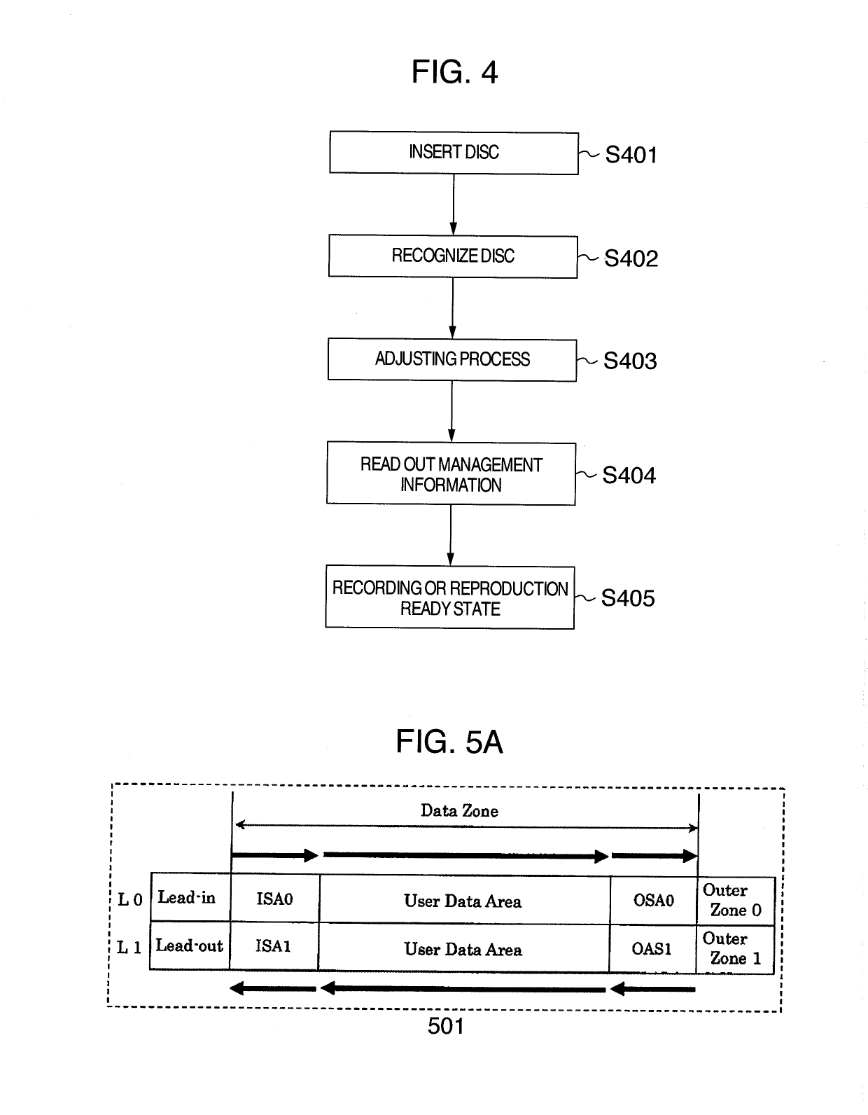

FIG. 4 shows a processing flow of the optical disc apparatus 101 at the time when the optical disc 102 has been inserted into the optical disc apparatus 101.

When the optical disc 102 is inserted into the optical disc apparatus 101 in S401, the optical disc apparatus 101 confirms the presence or absence of the disc and confirms a disc type in S402. At this time, for example, the optical disc apparatus 101 irradiates the laser beam onto the optical disc 102 and can recognize them by the reflected light.

Subsequently, in S403, an adjusting process for optimizing various kinds of parameters in the optical disc apparatus 101 is executed to the inserted optical disc 102. As various kinds of parameters, for example, a case where an amplification factor of an amplifier included in the focus control unit 212 or the tracking control unit 215 is adjusted in accordance with a reflectance of the optical disc 102 and the like can be mentioned.

After various kinds of adjustment were made, management information of the optical disc 102 is read out in S404.

When the processing routine advances to S405, the apparatus enters a recording or reproduction ready state and the recording or reproduction can be performed in accordance with a command from the host 103.

Timing for the adjusting process in S403 is not limited to the timing mentioned above but a part of the adjusting process may be executed after the management information reading process in S404, or the like.

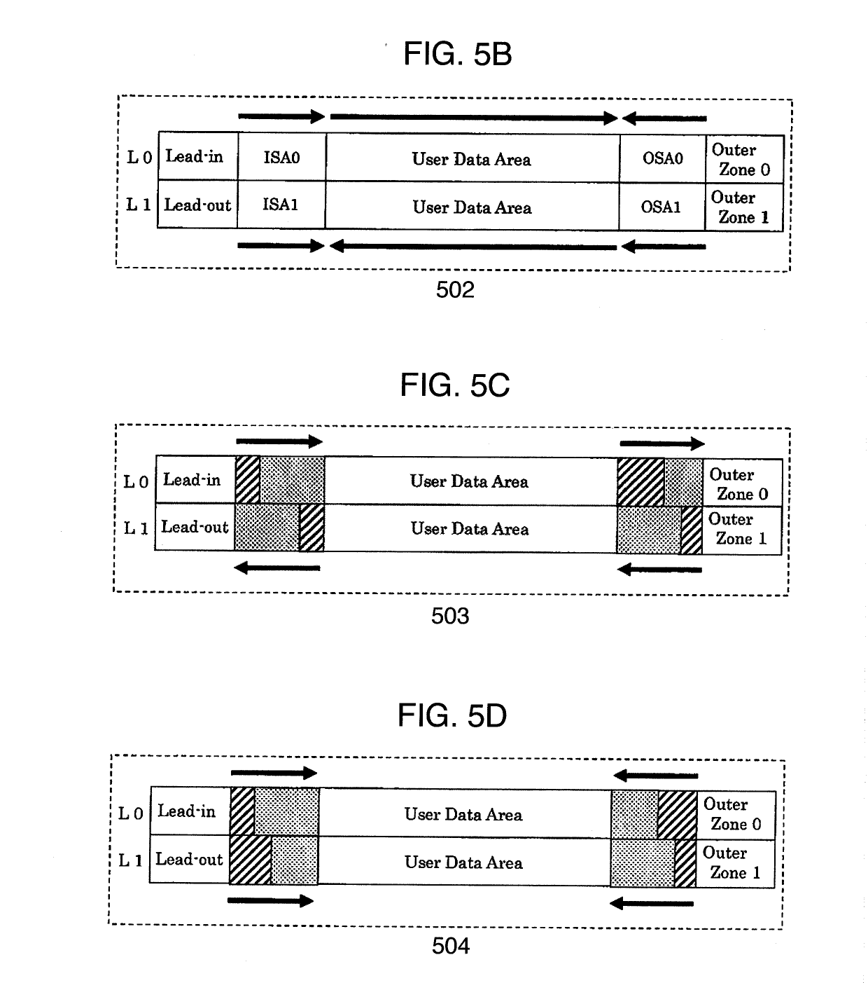

Subsequently, an alternation processing method in the BD will be described with reference to FIGS. 5A to 5D. The recording direction in the embodiment will be defined as follows. “is recorded in the forward track direction” denotes that the recording is performed while using addresses in ascending order. “is recorded in the opposite track direction” denotes that the recording is performed while using addresses in descending order. The data is recorded on a predetermined minimum recording unit basis. For example, in the case of the BD, the data is recorded on a Cluster unit basis and, in the case of the DVD, the data is recorded on an ECC block unit basis. Therefore, even in the case of performing the recording in the opposite track direction, when the data is seen on a minimum recording unit basis, the data is recorded in the same direction as the forward track direction.

FIG. 5A shows a disc structure example 501 of the BD-R DL and the direction in which the recording is performed (the direction in which the areas are used) is shown by arrows. User Data Area is an area where user data is recorded. In the defect management process, spare areas to record alternation data are located in an inner periphery and an outer periphery. The inner peripheral spare area is shown by ISA (Inner Spare Area) and the outer peripheral spare area is shown by OSA (Outer Spare Area), respectively. In the case of the BD-R DL, in both of the ISA and OSA, the direction in which the spare areas are consumed is the same forward track direction as the recording direction of the user data area. That is, in spare areas ISAO and OSA0 locating in an L0 layer, the areas are consumed from the inner peripheral direction toward the outer peripheral direction. In spare areas ISA1 and OSA1 locating in an L1 layer, the areas are consumed from the outer peripheral direction toward the inner peripheral direction. In the case of the BD-R, since a special reason why the spare areas are used in the opposite track direction does not exist, it is natural that the consuming direction is set to the same recording direction as that in the user data area.

FIG. 5B shows a disc structure 502 of the BD-RE DL. In the case of the BD-RE DL, the direction in which the spare areas are consumed is the forward track direction corresponding to the direction from the inner periphery to the outer periphery in the ISA and is the opposite track direction corresponding to the direction from the outer periphery to the inner periphery in the OSA. As mentioned above, in each of the OSA0 area of the L0 layer and the ISA1 area of the L1 layer, the direction in which the spare areas are consumed is equal to the opposite track direction different from the recording direction of the User Data Area. This is because in the rewriting type BD-RE, an expansion of the spare areas is scheduled. If the OSA0 and ISA1 are used from the forward track direction, the User Data Area and the spare areas are neighboring, so that the spare areas cannot be expanded.

A consideration will be made here with respect to a change in the case where, for example, the using directions of the spare areas in the BD-R and BD-RE are applied as they are to the grooveless disc in the embodiment. FIGS. 5C and 5D show examples in the case where the data has been recorded in the spare areas in accordance with the using directions of the spare areas in the disc structure 501 of the BD-R DL shown in FIG. 5A and the disc structure 502 of the BD-RE DL shown in FIG. 5B, respectively. A hatched area is an area in which the data has already been recorded and a meshed area is an unused area. In the BD-R/RE, even if there are unrecorded areas, since there is no problem in the data reproduction, it is permitted that the unrecorded areas are left as they are even after the finalizing process was executed. However, in the grooveless disc in the embodiment, there is a possibility that the padding process of the unrecorded areas is necessary. That is, in the case of executing the finalizing process in a state like a disc structure 503 of the BD-R DL in which the data has already been recorded in the spare areas as shown in FIG. 5C or a disc structure 504 of the BD-RE DL in which the data has already been recorded in the spare areas as shown in FIG. 5D, since it is necessary to execute the padding process to all of the meshed areas, it takes a long time in dependence on the capacity. Naturally, the larger the unused area is, the longer time is required.

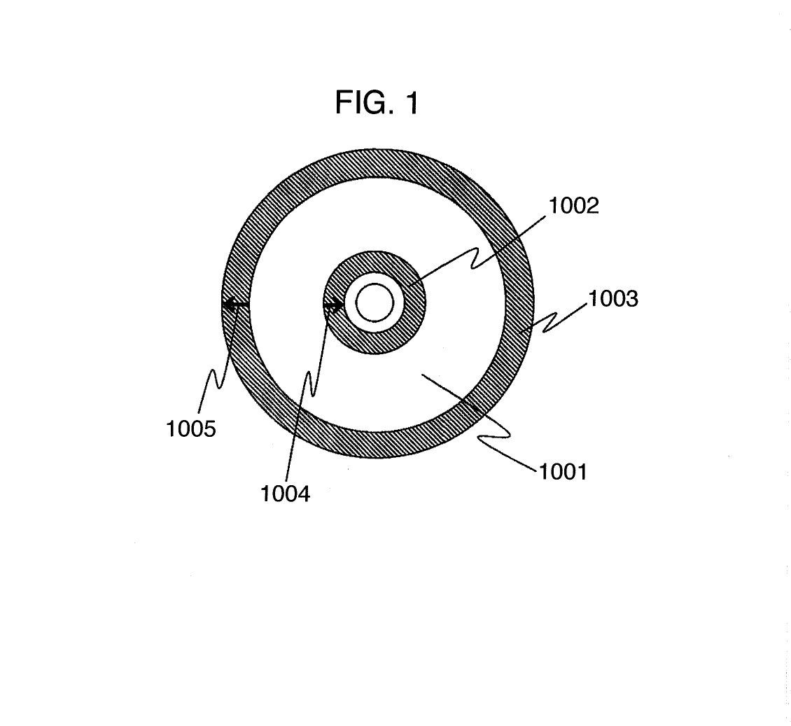

A layout and a using method of the spare areas in the optical disc 102 in the embodiment will now be described with reference to FIG. 1. FIG. 1 illustrates one of a plurality of recording layers in FIG. 3. An area 1001 includes at least a user data area, a management information storage area, other areas, and the like. An inner peripheral spare area 1002 is arranged on the inner peripheral side. An outer peripheral spare area 1003 is arranged on the outer peripheral side. Using directions of the inner peripheral spare area 1002 and the outer peripheral spare area 1003 will be described here. The inner peripheral spare area 1002 is used in a direction shown by an arrow 1004 in such a manner that the area is consumed on the side of the area adjacent to the area 1001, that is, it is consumed from the inner peripheral direction toward the outer peripheral direction of the disc. The outer peripheral spare area 1003 is used in a direction shown by an arrow 1005 in such a manner that the area is consumed on the side of the area adjacent to the area 1001, that is, it is consumed from the outer peripheral direction toward the inner peripheral direction of the disc. (In the case of the recording in the OTP, the directions shown by the arrows 1004 and 1005 may be in the forward track direction or in the opposite track direction according to the odd-number designated layer or the even-number designated layer.)

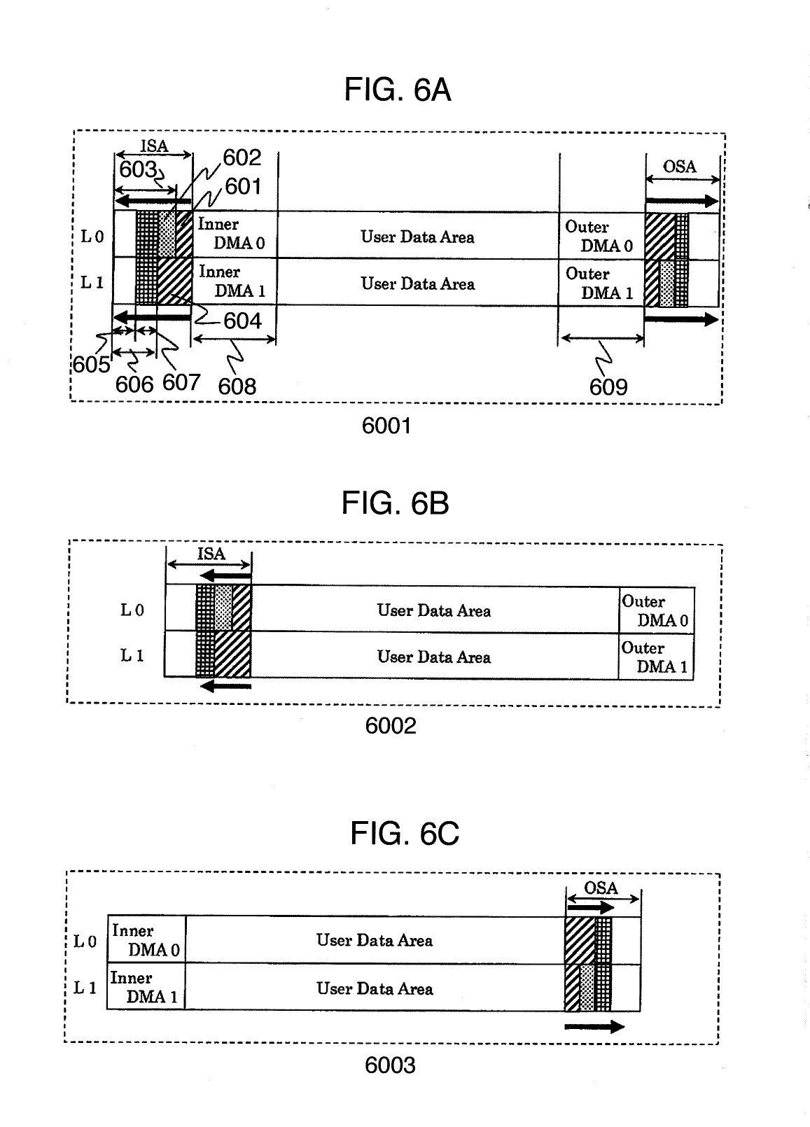

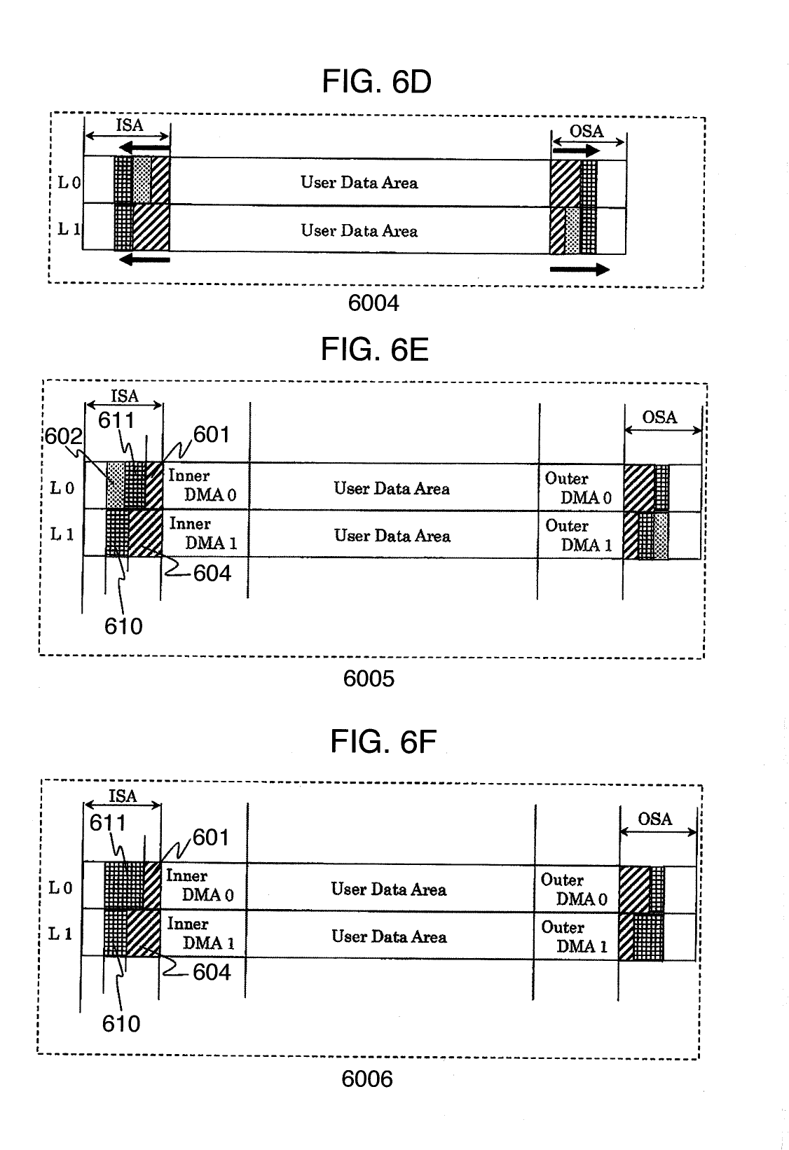

A point that in both of the inner peripheral spare area and the outer peripheral spare area, according to the method of consuming the areas from the side near the User Data Area, although it seems that no advantages are obtained unlike the cases of the disc structures 501 and 502, in the grooveless disc of the embodiment, such a method becomes effective will be described with reference to FIGS. 6A to 6F. In FIGS. 6A to 6F, reference numerals 6001, 6002, 6003, 6004, 6005, and 6006 denote examples of a disc layout of the spare areas which are considered from the use example of the spare areas in FIG. 1. In the layout examples 6001 to 6006, in common, the spare areas are located at the innermost peripheral position or the outermost peripheral position or at both of the innermost and outermost peripheral positions. First, the layout example 6001 shown in FIG. 6A will be described. An Inner DMA 608 located in an inner periphery of the User Data Area and an Outer DMA 609 located in an outer periphery are management information storage areas including management data which is temporarily recorded during the data recording, management data which is recorded upon finalization, and the like. An attention is paid to the spare area on the inner peripheral side and it will be time-sequentially explained. It is assumed that the alternation data was recorded into areas of up to a hatched area 601 in the L0 layer and the alternation data was recorded into areas of up to a hatched area 604 in the L1 layer. In the case of executing the finalizing process in this state, padding process subject areas (areas which are subjected to the padding process) are an area 603 of the L0 layer of the unrecorded area and an area 606 of the L1 layer. However, in both of the L0 layer and the L1 layer, there is no need to access the area 606 and if effective data does not exist either on the inner peripheral side thereof, the padding process of the area 606 is unnecessary. Therefore, the padding process is sufficient only to an area 602 of the L0 layer. However, in consideration of the area for tracking lead-in or the area for over-run, a necessary sufficient buffer area 607 may be recorded from a final recorded area (in the case of the layout example 6001, the area 604 of the L1 layer corresponds to such a final recorded area) of the layer in which the data has been recorded into areas of up to the innermost peripheral side. In this case, in both of the L0 layer and the L1 layer, since the padding process of the area 605 is unnecessary, it is sufficient that a time necessary for the padding process is shorter as compared with that in the case of executing the padding process to all of the area 603 of the L0 layer and the area 606 of the L1 layer. A capacity of the buffer area 607 differs depending on the designer. For example, there is considered a method whereby the buffer areas of the number corresponding to a distance (the number of tracks) from a recorded radial position are provided in consideration of an over-run due to a run-out from the recording area upon Seeking and in consideration of a Seek precision (feeding precision or the like of the slider) or a method whereby the buffer area is provided in such a manner that a recording capacity of the buffer in the outer periphery is set to be larger than that in the inner periphery by an amount corresponding to a ratio between a radius of the outer periphery and a radius of the inner periphery so as to equalize the buffer area of the inner periphery and the buffer area of the outer periphery when seen as the number of tracks.

Although a description about a case of the outer peripheral side is omitted here, it is similar to that in the case of the inner peripheral side. Although the DMA areas are provided for the inner and outer peripheries of all of the layers in the case of the layout example 6001, even if any one of the DMA areas among the layers does not exist, the processes can be similarly executed. It is necessary that the padding processes have been completed to all of the unrecorded portions in the User Data Area and the DMA areas of the Inner DMA 608 and the Outer DMA 609 at a point of time when the finalizing process was completed.

In the layout examples 6005 and 6006 shown in FIGS. 6E and 6F, although layouts of the DMAs and the spare areas are substantially the same as the layout example 6001, a recording method of the padding area and guard (buffer) area differs from that of the layout example 6001. First, the layout example 6005 shown in FIG. 6E will be described. It is assumed that the alternation data was recorded into the areas of up to the hatched area 601 in the L0 layer and the alternation data was recorded into the areas of up to the hatched area 604 in the L1 layer. In the case of executing the finalizing process in this state, a necessary sufficient buffer area 610 is recorded into the area 604 of the L1 layer from the final recorded area of the layer in which the data has been recorded into the areas of up to the innermost peripheral side in consideration of the area for over-run. Subsequently, an area 611 is also similarly recorded into the area 601 of the L0 layer in consideration of the buffer area for tracking lead-in. The area 602 is an area obtained by executing the padding process to the area corresponding to the buffer area 610 in consideration of an inter-layer jump.

Subsequently, the layout example 6006 shown in FIG. 6F will be described. It is assumed that the alternation data was recorded into the areas of up to the hatched area 601 in the L0 layer and the alternation data was recorded into the areas of up to the hatched area 604 in the L1 layer. In the case of executing the finalizing process in this state, to the area 604 of the L1 layer, in consideration of the guard area for over-run, the necessary sufficient buffer area 610 is recorded from the final recorded area of the layer in which the data has been recorded into the areas of up to the innermost peripheral side. Although the area 611 is an area obtained by executing the padding process to the area corresponding to the buffer area 610 in consideration of the inter-layer jump, the area 611 eventually also plays a role of the buffer area for tracking lead-in to the area 601. As mentioned above, in the layout examples 6001, 6005, and 6006, although the recording order in each area and the arranging locations differ, the areas which have been recorded are eventually the same and the same effect is obtained in all of them.

Subsequently, the layout examples 6002, 6003, and 6004 illustrated in FIGS. 6B to 6D will be described. The layout example 6002 relates to a case where the spare area exists in the inner periphery and the spare area does not exist in the outer periphery. The layout example 6003 relates to a case where the spare area does not exist in the inner periphery and the spare area exists in the outer periphery. The layout example 6004 relates to a case where the management information storage area does not exist in both of the inner periphery and the outer periphery. In the case of the layout example 6004, it is presumed that the management information storage areas exist in the guide layer and the like in the embodiment. In any of the above cases, they can be explained in a manner similar to the case described in the layout example 6001 and a similar effect is obtained.

As mentioned above, in the grooveless disc, the spare areas are arranged in the innermost periphery and the outermost periphery, the spare area on the innermost peripheral side is used from the outer peripheral direction toward the inner peripheral direction, and the spare area on the outermost peripheral side is used from the inner peripheral direction toward the outer peripheral direction, thereby reducing the wasteful padding processing areas of the spare areas and realizing a reduction in time of the finalizing process. Although the embodiment has been described above with respect to the example of the disc of double layers, a similar effect is obtain in the case of the disc of single layer or three or more layers.

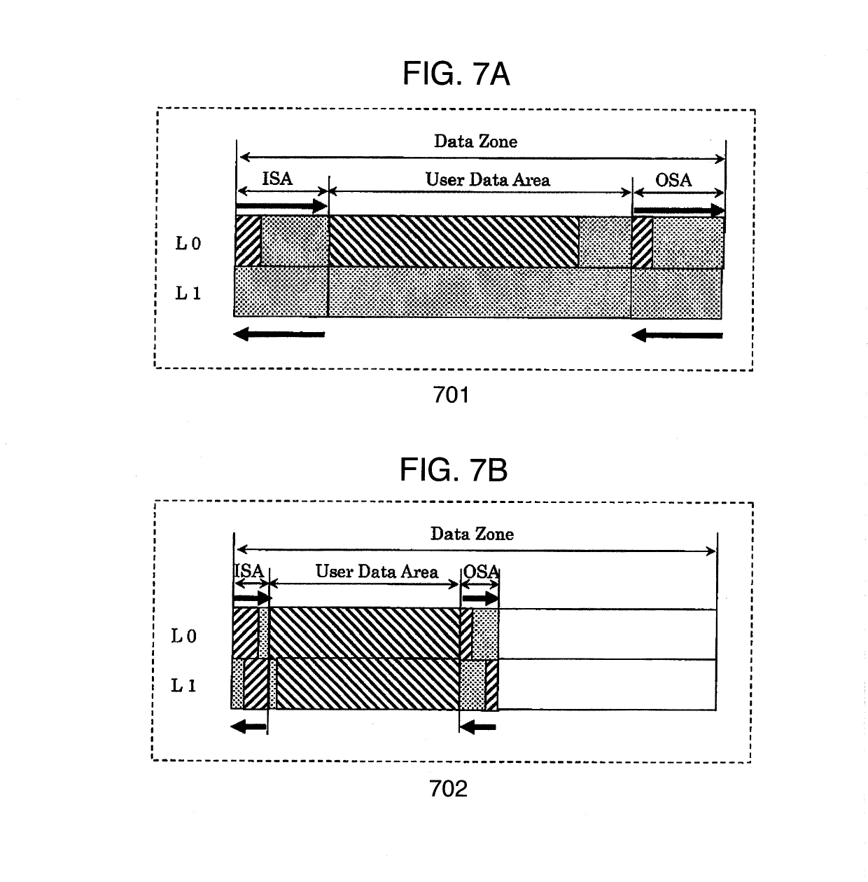

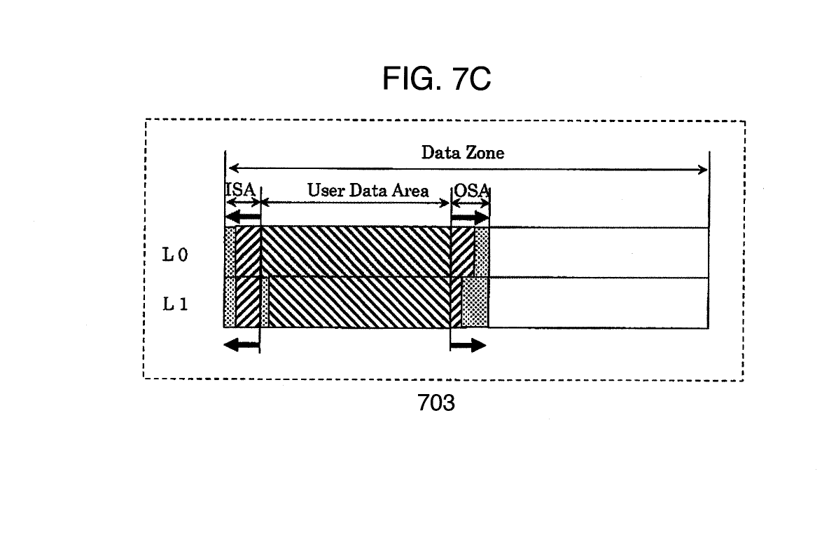

Subsequently, in the grooveless disc, there is considered a case of decreasing an amount of padding process in the case where the spare areas are used in the same directions as the using directions shown in the case 501 in FIG. 5A and an amount of data to be recorded onto the optical disc has previously been known and the recording is performed in a manner of DAO (Disc At Once) of the DVD. This point will now be described with reference to FIGS. 7A to 7C. In the BD-R, the spare areas are preliminarily assured by an instruction (instruction of an application) from the host side at the time of formatting the disc. There is a case where a defect area of the disc occurs not only by a defect that is caused by a scratch due to a partial damage of the medium, a fingerprint, a fouling, a deterioration of a recording film, or the like but also by an inherent poor quality of the disc. If the spare areas of a larger amount are assured at the time of formatting, even if many defects occurred, the data can be recorded into the spare areas. Therefore, the reliability of the disc is raised and it is advantageous to the user. However, if the spare areas of a large amount are assured, a user data recording area decreases consequently in association with it and it is disadvantageous to the user. That is, there is a relation of trade-off. Whether or not the spare areas are used in the actual data recording also depends on disc quality, drive performance, and data recording environment. Therefore, it is a present situation that the same spare area capacity is, generally, assured for all media. In other words, as shown in FIG. 7A, in a case 701, a ratio of the ISA and OSA which are allocated to the Data Zone is constant irrespective of the data recording amount. For example, in the case 701, even in the case where the data is recorded to a halfway position of the User Data Area of the L0 layer or in the case where the data is recorded into all of the L0 layer and the L1 layer, the capacities of the spare areas which are assured are equal.

A case where the case 701 relates to the grooveless disc will now be considered. In the case of the BD-R, since the padding process is unnecessary, there is no problem in particular. However, in the grooveless disc, for example, if the user was recorded only to the halfway position of the L0 layer, the padding process is necessary to meshed areas in the case 701, so that it takes a long time for the padding process and it will be a waste of time. A method for solving such a problem will be described in a case 702.

First, an example of the DAO recording will be described. If the amount of data to be recorded has previously been known, a method of enabling a turning point from L0 to L1 to be designated from the host also exists. According to such a method, the capacity of the data which is recorded is distributed to each layer so as to be substantially equalized, thereby allowing the amount of data which is used in each layer to be substantially equalized from the inner periphery. A case where such a recording method is also applied to the grooveless disc and the DAO recording is performed will now be considered.

Subsequently, a method of assuring the spare area capacity in the present case will be described. In the case 702, as an spare area capacity which is assured, the same capacity is not uniformly assured to the Data Zone (whole capacity of the disc) but is decided in accordance with the capacity of the user data which is recorded. For example, if the capacity of 10% of the capacity of the User Data Area has been assured, when it is assumed that the capacity of the User Data Area is equal to, for example, 100, the spare area capacity is equal to 10. However, if only the half of the User Data Area is used, the spare area capacity of 5 which is equal to the half of 10 is supposed to be sufficient. In other words, if the capacity of the user data which is used is small, it is also sufficient that the spare area capacity is relatively small. Therefore, there is no need to wastefully assure the spare areas in which a possibility that they are not used is high. The capacities of the ISA and OSA are reduced by such a method, so that the areas which need the padding process can be decreased. Although the recording which is performed after the capacity of each layer was almost equalized has been presumed in the case 702, even if they are not always equalized, a similar effect is obtained. Although the disc of the double layers has been described in the case 702, naturally, even in the case of a disc of single layer or three or more layers, a similar effect is obtained. Although a case 703 relates to a case where the using direction of the ISA of L0 and the using direction of the OSA of L1 in the case 701 shown in FIG. 7A are opposite to those in the case 702 shown in FIG. 7B, the case 703 can be explained in a manner similar to that of the case 702 and a similar effect is obtained.

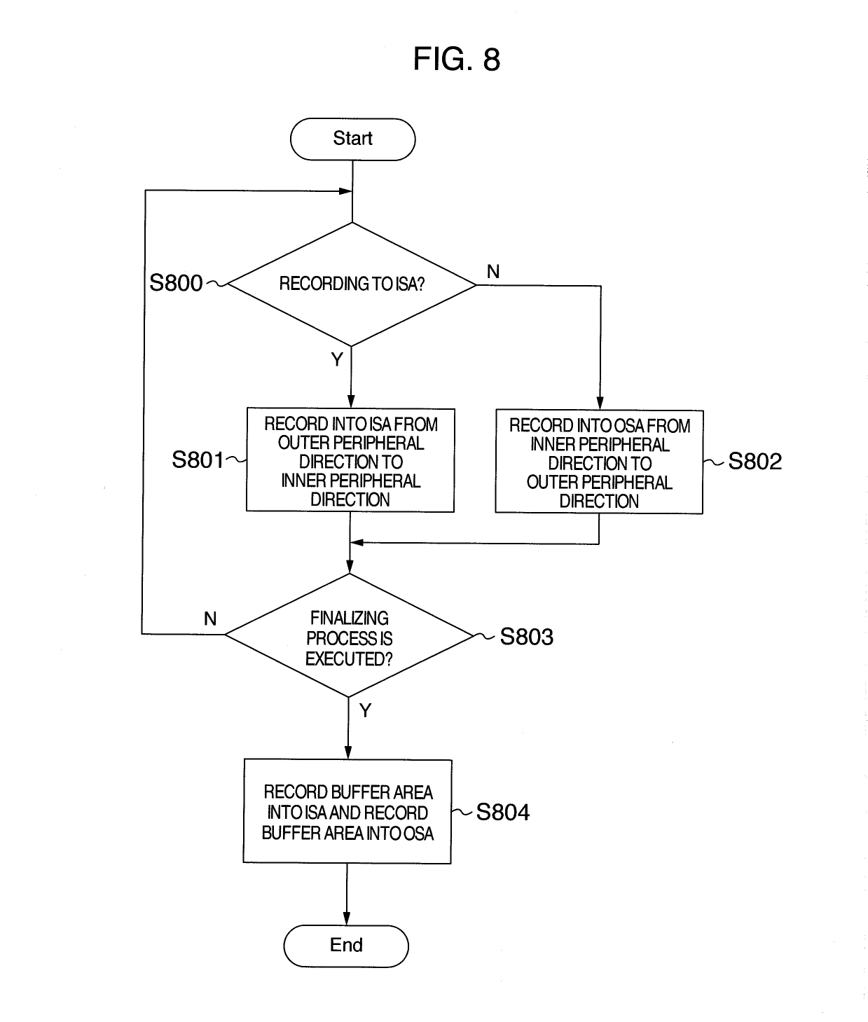

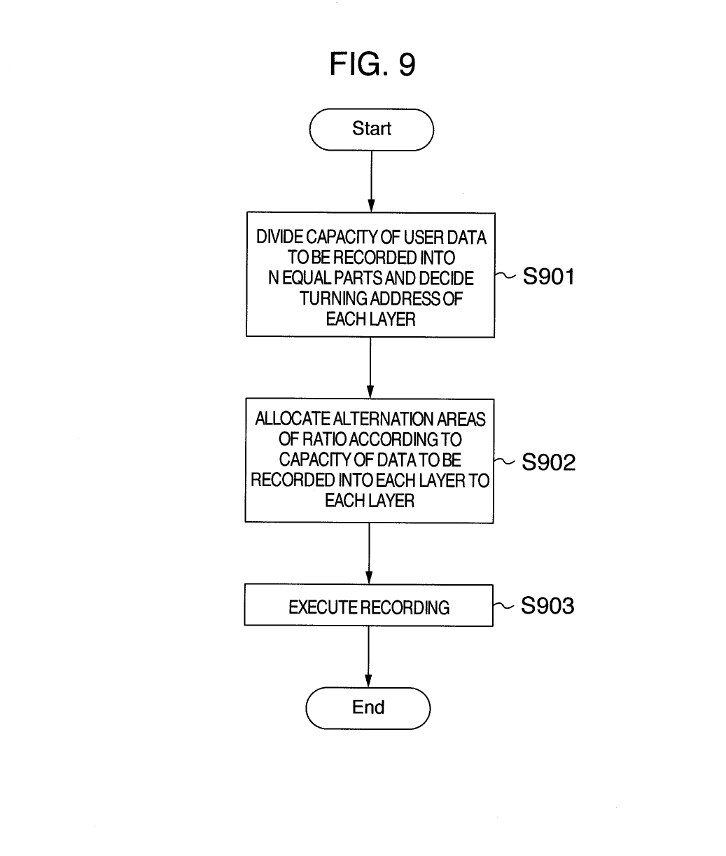

Finally, a process for executing the recording into the spare areas in the cases of FIGS. 6A to 6F in the embodiment will be described with reference to a flowchart of FIG. 8, and a method of deciding the capacities of the spare areas in the cases of FIGS. 7A to 7C will be described with reference to a flowchart of FIG. 9.

The flowchart of FIG. 8 will now be described. First, when the recording is performed to the spare areas, whether or not the recording is the recording to the spare area on the inner peripheral side is discriminated (S800). In the case of recording into the spare area on the inner peripheral side, the alternation data is recorded from the outer peripheral direction toward the inner peripheral direction (S801). In the case of recording into the spare area on the outer peripheral side, the alternation data is recorded from the inner peripheral direction toward the outer peripheral direction (S802). Further, whether or not the finalizing process is executed is discriminated (S803). In the case of executing the finalizing process, the buffer areas are recorded into both of the spare area on the inner peripheral side and the spare area on the outer peripheral side (S804) and the processing routine is finished.

Subsequently, the flowchart of FIG. 9 will now be described. This flowchart relates to the method of deciding the capacity of the whole spare areas in the case where the data is recorded to the grooveless disc constructed by N layers (N is a natural number) and the capacity of the user data which is recorded has been predetermined and the recording process including the finalizing process is executed in a lump. First, the capacity of the user data which is recorded is divided into N equal capacities and a turning address of each layer is decided (S901). (The whole capacity is not always divided into the equal capacities.) The spare areas of a ratio corresponding to the capacity of the data which is recorded into each layer is allocated to each layer (S902) and the recording is executed (S903).

Although the invention has been described above with respect to the case where the recording layer is constructed by single layer or double layers, naturally, even in the case where the recording layer is constructed by three or more layers, a similar effect is obtained. The invention is not limited to the optical disc described in the present embodiment but, naturally, the invention can be also applied to any recording medium irrespective of the presence or absence of the guide layer or the number of recording layers so long as it has a concept such as spare areas and a similar effect is obtained.

As mentioned above, according to the invention, in the grooveless disc, by devising the arranging positions, capacities, and using directions of the spare areas, the number of areas which need the padding process can be reduced and the time necessary for the finalizing process can be reduced.

It should be further understood by those skilled in the art that although the foregoing description has been made on embodiments of the invention, the invention is not limited thereto and various changes and modifications may be made without departing from the spirit of the invention and the scope of the appended claims.

1. A medium in which information is recorded, comprising:
a guide layer of one or two layers each having a spiral track added with address information; and
a plurality of recording layers in which depth positions from said guide layer differ,
wherein a user data area, spare areas, and a management information storage area for storing information about use of said spare areas are included in each of said plurality of recording layers,
an inner peripheral spare area locating on an inner peripheral side of said user data area is configured so as to be used to record the information from an outer peripheral direction toward an inner peripheral direction, and an outer peripheral spare area locating on an outer peripheral side of said user data area is configured so as to be used to record the information from the inner peripheral direction toward the outer peripheral direction.

2. The medium according to claim 1, wherein in a state where said medium has been subjected to a finalizing process, a buffer area of a predetermined amount is recorded from a final recording position in said inner peripheral spare area to the inner peripheral direction, and a buffer area of a predetermined amount is recorded from a final recording position in said outer peripheral spare area to the outer peripheral direction.

3. The medium according to claim 1, wherein after a user data recording capacity to said medium was decided, if a recording process including a finalizing process has been executed, an amount corresponding to said user data recording capacity is assumed for said spare areas.

4. A recording method of recording information to a medium, wherein
said medium has a guide layer of one or two layers each having a spiral track added with address information and a plurality of recording layers in which depth positions from said guide layer differ, and a user data area, spare areas, and a management information storage area for storing information about use of said spare areas are included in each of said plurality of recording layers,
in an inner peripheral spare area locating on an inner peripheral side of said user data area, the information is recorded from an outer peripheral direction toward an inner peripheral direction, and in an outer peripheral spare area locating on an outer peripheral side of said user data area, the information is recorded from the inner peripheral direction toward the outer peripheral direction.

5. The method according to claim 4, wherein when said medium is subjected to a finalizing process, a buffer area of a predetermined amount is recorded from a final recording position in said inner peripheral spare area to the inner peripheral direction, and a buffer area of a predetermined amount is recorded from a final recording position in said outer peripheral spare area to the outer peripheral direction.

6. The method according to claim 4, wherein after a user data recording capacity to said medium was decided, when a recording process including a finalizing process is executed, a capacity of said spare areas is changed in accordance with said user data recording capacity.

7. A recording apparatus for recording information to a medium, wherein said medium has a guide layer of one or two layers each having a spiral track added with address information and a plurality of recording layers in which depth positions from said guide layer differ, and a user data area, spare areas, and a management information storage area for storing information about use of said spare areas are included in each of said plurality of recording layers,
said recording apparatus has an spare area recording unit for executing an alternation process by using said spare areas, and
said spare area recording unit records the information from an outer peripheral direction toward an inner peripheral direction in the case of recording into an inner peripheral spare area locating on an inner peripheral side of said user data area and records the information from the inner peripheral direction toward the outer peripheral direction in the case of recording into an outer peripheral spare area locating on an outer peripheral side of said user data area.

8. The apparatus according to claim 7, wherein when said medium is subjected to a finalizing process, said spare area recording unit records a buffer area of a predetermined amount from a final recording position in said inner peripheral spare area to the inner peripheral direction and records a buffer area of a predetermined amount from a final recording position in said outer peripheral spare area to the outer peripheral direction.

9. The apparatus according to claim 7, further comprising an spare area capacity deciding unit, and
wherein after a user data recording capacity to said medium was decided, when a recording process including a finalizing process is executed, said spare area capacity deciding unit changes a capacity of said spare areas in accordance with said user data recording capacity.

10. A medium in which information is recorded, comprising:
a guide layer of one or two layers each having a spiral track added with address information; and
a plurality of recording layers in which depth positions from said guide layer differ,
wherein a user data area, spare areas, and a management information storage area for storing information about use of said spare areas are included in each of said plurality of recording layers,
an area locating in an innermost periphery is an spare area on an inner peripheral side, and an area locating in an outermost periphery is an spare area on an outer peripheral side.

11. A medium in which information is recorded, comprising:
a guide layer of one or two layers each having a spiral track added with address information; and
a plurality of recording layers in which depth positions from said guide layer differ,
wherein a user data area, spare areas, and a management information storage area for storing information about use of said spare areas are included in each of said plurality of recording layers,
an area locating in an innermost periphery is said spare area, and an area locating in an outermost periphery is said management information storage area.

12. A medium in which information is recorded, comprising:
a guide layer of one or two layers each having a spiral track added with address information; and
a plurality of recording layers in which depth positions from said guide layer differ,
wherein a user data area, spare areas, and a management information storage area for storing information about use of said spare areas are included in each of said plurality of recording layers,
an area locating in an innermost periphery is said management information storage area, and an area locating in an outermost periphery is said spare area.

13. The recording method of the medium according to claim 10, wherein in the case of recording into said spare areas, in the spare area locating on the inner peripheral side, the information is recorded from the outer peripheral direction to the inner peripheral direction, and in the spare area locating on the outer peripheral side, the information is recorded from the inner peripheral direction to the outer peripheral direction.

14. The recording method of the medium according to claim 11, wherein in the case of recording into said spare areas, in the spare area locating on the inner peripheral side, the information is recorded from the outer peripheral direction to the inner peripheral direction, and in the spare area locating on the outer peripheral side, the information is recorded from the inner peripheral direction to the outer peripheral direction.

15. The recording method of the medium according to claim 12, wherein in the case of recording into said spare areas, in the spare area locating on the inner peripheral side, the information is recorded from the outer peripheral direction to the inner peripheral direction, and in the spare area locating on the outer peripheral side, the information is recorded from the inner peripheral direction to the outer peripheral direction.
